(19) United States
(12) Patent Application Publication
(10) Pub. No.: US 2010/0152387 A1
(43) Pub. Date: Jun. 17, 2010

(54) ISOTACTIC POLYSTYRENE HAVING REACTIVE GROUPS

(75) Inventors: Helmut Steininger, Worms (DE); Konrad Knoll, Mannheim (DE); Rolf Mülhaupt, Freiburg (DE); Barbara Gall, Freiburg (DE); Frédéric Pelascini, Ostwald (FR)

Correspondence Address: CONNOLLY BOVE LODGE & HUTZ LLP, 1875 EYE STREET, N.W., SUITE 1100, WASHINGTON, DC, 20006, US

(73) Assignee: BASF SE, Ludwigshafen (DE)

(21) Appl. No.: 12/601,147

(22) PCT Filed: May 7, 2008
(86) PCT No.: PCT/EP2008/055625

§ 371 Date: Nov. 20, 2009

(30) Foreign Application Priority Data
May 23, 2007 (EP) 07108764.7

(51) Int. Cl. C08F 8/08; C08F 212/08; C08F 4/76; C08F 226/02; C08F 230/08; C08F 214/00; C08F 4/80

(52) U.S. Cl. 525/107; 526/347; 526/172; 526/310; 526/279; 526/291; 526/171

(57) ABSTRACT

The present invention relates to a process for preparing functionalized isotactic polystyrene, functionalized isotactic polystyrene which can be prepared by the process of the invention, the use of the functionalized isotactic polystyrene of the invention as macromonomer, a process for preparing a macroinitiator, a macroinitiator which can be prepared by the abovementioned process, the use of the macroinitiator for controlled free-radical polymerization, the use of the functionalized isotactic polystyrene of the invention as macromonomer, preferably in copolymerization with olefins, ROMP with cycloolefins or for coupling with silicone segments, a process for epoxidizing the functionalized isotactic polystyrene of the invention, epoxidized isotactic polystyrene which can be prepared by the abovementioned process and a process for preparing soft thermoplastic elastomers (TPEs) by metathesis polymerization of the functionalized isotactic polystyrene of the invention with suitable polymers which have terminal double bonds and soft thermoplastic elastomers which can be prepared by the process of the invention.

The present invention relates to a process for preparing functionalized isotactic polystyrene, functionalized isotactic polystyrene which can be prepared by the process of the invention, the use of the functionalized isotactic polystyrene of the invention as macromonomer, a process for preparing a macroinitiator, a macroinitiator which can be prepared by the abovementioned process, the use of the macroinitiator for controlled free-radical polymerization, the use of the functionalized isotactic polystyrene of the invention as macromonomer, preferably in copolymerization with olefins, ROMP with cycloolefins or for coupling with silicone segments, a process for epoxidizing the functionalized isotactic polystyrene of the invention, epoxidized isotactic polystyrene which can be prepared by the abovementioned process and a process for preparing soft thermoplastic elastomers (TPEs) by metathesis polymerization of the functionalized isotactic polystyrene of the invention with suitable polymers which have terminal double bonds and soft thermoplastic elastomers which can be prepared by the process of the invention.

There is great interest in structurally defined functionalized polymers which can be used, for example, as macroinitiators or macromonomers for producing novel materials.

Macroinitiators and macromonomers based on polystyrene are known in the prior art. In general, the macromonomer synthesis requires a multistage process, for example anionic styrene polymerization and chain termination by means of functionalizing reagents. Most anionically prepared styrene polymers are atactic.

Lutz et al., Macromol. Rapid Commun. 2004, 25, 1010 to 1014, discloses the homopolymerization of ω-styrylpolystyrene macromonomers in the presence of titanocene catalysts. The macromonomers are prepared by anionic styrene polymerization and chain termination.

Lutz et al., Macromol. Symp. 2004, 213, 253 to 263, discloses the homopolymerization and copolymerization of polystyrene macromonomers functionalized at the end groups to give comb-like polymers. In this case, too, the macromonomers are prepared by anionic polymerization and chain termination by means of suitable functionalizing reagents.

However, the anionic polymerization of styrene is not suitable for preparing highly isotactic polystyrene (see Cazzaniga et al. Macromolecules 1989, 22, 4125 to 4128, Makino et al. Macromolecules 1999, 32, 5712 to 5714).

The preparation of isotactic polystyrene can be carried out, for example, over Nd-based catalysts (Liu et al., J. Polym. Sci. A: Polym. Chem. 1998, 36, 1773 to 1778). Furthermore, isospecific polymerization of styrene can be carried out using ansa-zirconocene catalysts (Arai et al. Olefin Polymerisation, 2000, Vol. 749) and using nickel complexes (Ascenso et al., Makromolecules 1996, 29, 4172 to 4179, Crossetti et al., Macromol. Rapid Commun. 1997, 18, 801, Po et al., J. Polym. Sci. A: Polym. Chem. 1998, 36, 2119 to 2126). However, these approaches are limited by the incomplete stereoregularity of the products and by low molecular weights in the case of the nickel catalysts.

A further process for preparing isotactic polystyrene is disclosed in Proto, Mülhaupt, Okuda et al., J. Am. Chem. Soc. 2003, 125, 4964 to 4965. This document discloses the preparation of isotactic polystyrene by means of C₂-symmetric group IV metal bis(phenoxide) catalysts.

Isotactic polystyrene obtained hitherto is of no commercial importance because of its strongly kinetically inhibited crystallization, although its melting point of about 220° C. makes it an interesting industrial material or an interesting starting material for producing novel materials.

In the thesis by H. Ebeling “Katalytische Styrol-Homo-und Copolymerisation und neue Cycloolefinpolymere auf der Basis von 1,3-Cyclohexadien”, Freiburg i. Br. 2004, the regulation of the molecular weight in the preparation of iPs by catalytic polymerization of styrene in the presence of 1-hexene is examined. Furthermore, copolymers of 1,3-cyclohexadiene with styrene are described. The preparation of functionalized iPs which can serve, for example, as macroinitiator, macromonomer or coupling reagent is not disclosed in the thesis.

It is therefore an object of the present invention to provide highly isotactic polystyrene which can serve as macroinitiator, macromonomer or coupling reagent for the preparation of novel materials by further functionalization or further reaction. To make further functionalization or reaction possible, the highly isotactic polystyrene has to bear functional groups.

The present invention thus has the aim of providing stereoregular styrene polymers which are suitable as macromonomers, macroinitiators or coupling reagents to control molecular architecture. These can be used for preparing novel copolymers (e.g. block or graft copolymers) and novel materials.

This object is achieved by a process for preparing functionalized isotactic polystyrene, which comprises the step:
(i) catalytic polymerization of styrene in the presence of at least one iso-selective metal-organic catalyst and at least one C₅-C₃₀-olefin which has a further function in addition to the double bond.

It has been found that incorporation of the C₅-C₃₀-olefins which have a further function in addition to the double bond occurs essentially at the chain ends of the polystyrene. In general, not more than 15 mol %, preferably not more than 10 mol %, particularly preferably not more than 5 mol %, of the olefins are incorporated into the polystyrene chain. The C₅-C₃₀-olefins used in the process of the invention serve simultaneously to effect functionalization and to control the molecular weight by acting as an effective chain transfer reagent.

The further function of the C₅-C₃₀-olefin is, for example, a further double bond which is generally not conjugated with the double bond already present in the C₅-C₃₀-olefin. Furthermore, the further function can be an OH group, amino group, halogen, an alkylsilyl group. These functional groups are generally not arranged in the vinylic position relative to the existing double bond. The existing double bond of the C₅-C₃₀-olefin is preferably located at a chain end of the olefin (in the ω position) and the further functional group is located at the other chain end of the olefin (in the ω position).

In the following, the expression “C₅-C₃₀-olefin” refers to a C₅-C₃₀-olefin which has a further function in addition to the existing double bond, with preferred functions having been mentioned above.

The styrene concentration in the process of the invention is generally from 0.1 to 8 mol/l, preferably from 0.5 to 5 mol/l, particularly preferably from 1.0 to 2.5 mol/l. The concentration of the C₅-C₃₀-olefin used according to the invention is dependent on the desired molar mass and can be determined without problems by a person skilled in the art.

The molecular weight of the functionalized isotactic polystyrenes prepared according to the invention is dependent on the concentration ratio of the concentration of the C₅-C₃₀-olefin used to the concentration of styrene. The higher the c(olefin)/c(styrene) ratio, the lower the molecular weight. Furthermore, it has been found that the effects of the concentration ratio of C₅-C₃₀-olefin to styrene on the molecular weight distribution of the functionalized isotactic polystyrene are small.

As catalyst, it is in principle possible to use any metal-organic catalyst which is iso-selective in the catalytic polymerization of styrene. Such iso-selective metal-organic catalysts are usually catalysts which have C₂ symmetry.

Preference is given to using a C₂-symmetric group IV metal bis(phenoxide) catalyst in the process of the invention. Catalysts which are particularly preferably used in the process of the invention have the general formula I:

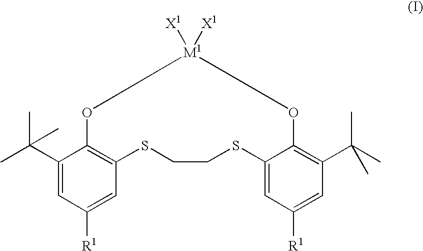

where M¹, R¹, X¹ in the formula I have the following meanings:
M¹ is Ti, Zr, Hf, preferably Ti;
R¹ is (C₁-C₆)-alkyl, O—(C₁-C₆)-alkyl, preferably (C₁-C₆)-alkyl, O—(C₁-C₄)-alkyl, particularly preferably methyl, t-butyl, O-methyl, very particularly preferably t-butyl;
X¹ is halogen, O—(C₁-C₄)-alkyl, aralkyl, preferably F, Cl, O(ⁱPr)₂, CH₂Ph, particularly preferably Cl.

Particular preference is given to using a catalyst of the formula I in the polymerization process of the invention. Very particular preference is given to using a catalyst of the formula I in which M¹ is Ti, X¹ is Cl and R¹ is methyl or t-butyl.

The catalyst of the formula I and processes for preparing it are disclosed, for example, in Proto, Mülhaupt, Okuda et al. J. Am. Chem. Soc. 2003, 125, 4964 to 4965, and the references cited therein.

The concentration of the catalyst used in the process of the invention is generally from 10 to 200 μmol/l, preferably from 20 to 100 μmol/l, particularly preferably from 30 to 80 μmol/l.

The polymerization process of the invention is generally carried out in a solvent. Suitable solvents are aromatic hydrocarbons, for example toluene, or halogenated hydrocarbons, e.g. dichloromethane. The polymerization process of the invention is preferably carried out in toluene as solvent. It is likewise possible in principle to carry out the polymerization in styrene without addition of a further solvent.

The reaction temperature in the process of the invention is generally from 20 to 80° C., preferably from 20 to 60° C.

The C₅-C₃₀-olefin used in the process of the invention, which has a further function in addition to the double bond, preferably has the general formula IIIa or IIIb:

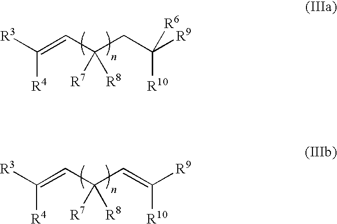

where:
R³, R⁴, R¹⁰, R⁷, R⁸, R⁹ are each
   H, (C₁-C₆)-alkyl, preferably H, (C₁-C₄)-alkyl, particularly preferably H, methyl, very particularly preferably H;
R⁶ is OH, amino, halogen or alkylsilyl, preferably OH, halogen or alkylsilyl,
n is from 2 to 10, preferably from 2 to 8, particularly preferably from 4 to 8.

Suitable amino groups are NR′R″ groups, where R′ and R″ are each, independently of one another, H or C₁-C₆-alkyl.

Suitable halogen groups are F, Cl, Br, I, preferably Cl or Br.

Suitable alkylsilyl groups are SiR′″R″″R″″′ groups, where R′″, R″″ and R″″′ are each, independently of one another, C₁-C₆-alkyl.

In the C₅-C₃₀-olefin having at least one terminal, nonconjugated double bond of the formula IIIa or IIIb, very particular preference is given to the radicals R³, R⁴, R¹⁰, R⁷, R⁸ and R⁹ each being H and n being from 4 to 8, and R⁶ in the 1-olefin of the formula IIIa is very particularly preferably OH.

In an embodiment of the process of the invention, use is thus made of 1-olefins which have from 5 to 30 carbon atoms and are substituted by an OH group, amino group, halogen or an alkylsilyl group.

This gives functionalized isotactic polystyrenes which have a group IVa:

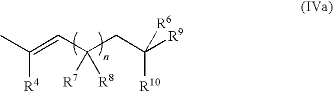

at least one chain end.

Preferred 1-olefins are 1-olefins having from 8 to 12 carbon atoms, e.g. dec-1-en-10-ol, 10-bromodec-1-ene, 10-chlorodec-1-ene, undec-1-en-11-ol, 11-bromoundec-1-ene, 11-chloroundec-1-ene or 11-alkylsilylundec-1-ene.

In a further embodiment of the process of the invention, C₅-C₃₀-dienes having nonconjugated double bonds are used. This gives isotactic polystyrene which has a vinyl group at least one chain end (vinyl-terminated isotactic polystyrene). The functionalized polystyrene in this embodiment preferably has a group IVb:

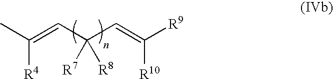

at least one chain end.

Preferred C₅-C₃₀-dienes having nonconjugated double bonds are dienes having from 8 to 12 carbon atoms, e.g. 1,7-octadiene, 1,8-nonadiene, 1,9-decadiene, 1,10-undecadiene and 1,11-dodecadiene.

The above-described polymerization process according to the invention comprising the step (i) makes it possible to obtain macromonomers, macroinitiators, block and graft copolymers and also inorganic/organic hydrides having stereoregular, narrowly distributed polystyrene segments.

The process of the invention thus makes novel functionalized isotactic polystyrenes accessible.

The present invention therefore provides functionalized isotactic polystyrene which is functionalized at least one chain end by a group selected from among the groups IVa and IVb

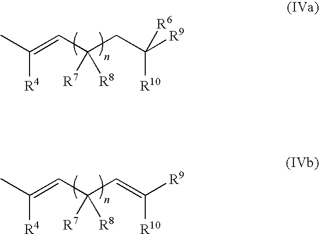

where
R³, R⁴, R⁵, R¹⁰, R⁷, R⁸
   are each, independently of one another, H, (C₁-C₆)-alkyl, preferably H; (C₁-C₄)-alkyl, particularly preferably H, methyl, very particularly preferably H;
R⁶ is OH, amino, halogen or alkylsilyl, preferably OH, halogen or alkylsilyl;
n is from 2 to 10, preferably from 2 to 8, particularly preferably from 4 to 8;
   and can be prepared by the process of the invention.

Preferred radicals R⁴, R⁶, R⁷, R⁸, R⁹ and R¹⁰ and preferred indices n correspond to the radicals and indices mentioned above for the compounds of the formulae IIIa and IIIb.

Preference is given to one chain end of the isotactic polystyrene being functionalized by a group IVa or IVb.

The present invention thus provides, in one embodiment, functionalized isotactic polystyrene which can be prepared by reaction with functionalized 1-olefins having from 5 to 30 carbon atoms and is functionalized at least one chain end by a group IVa. Very particularly preferred groups IVa are derived from the very particularly preferred functionalized 1-olefins, e.g. dec-1-en-10-ol, 10-bromodec-1-ene, 10-chloro-dec-1-ene, 10-alkylsilyldec-1-ene, undec-1-en-11-ol, 11-bromoundec-1-ene, 11-chloro-undec-1-ene or 11-alkylsilylundec-1-ene.

In a further embodiment, the present invention provides functionalized isotactic polystyrene which can be prepared by reaction with C₅-C₃₀-dienes having a further nonconjugated double bond and is functionalized at least one chain end by a group IVb. Very particularly preferred groups IVb are derived from the very particularly preferably dienes 1,7-octadiene, 1,8-nonadiene, 1,9-decadiene, 1,10-undecadiene or 1,11-dodecadiene.

The functionalized isotactic polystyrene of the invention is, due to the presence of the at least one function, able to be functionalized further by means of polymer-analogous reactions or to serve as macromonomer, macroinitiator or coupling reagent in further polymerization reactions. In this way, it is possible to obtain novel polymers such as stereoregular block copolymers, copolymers having lateral stereoregular polystyrenes and also block copolymers prepared by means of a coupling reaction, e.g. block copolymers having silicone segments. Here, the high degree of kinetic inhibition of the crystallization of the isotactic polystyrene, which has hitherto been considered to be a disadvantage in the prior art, represents an advantage since the further reaction of the functionalized isotactic polystyrene is aided by, for example, its better solubility compared to syndiotactic polystyrene (as long as crystallization of the isotactic polystyrene has not occurred).

The functionalized isotactic polystyrene of the invention preferably has an iso-specificity of ≧94%, preferably ≧96%, particularly preferably ≧98%. The iso-specificity is determined by means of ¹³C-NMR using methods known to those skilled in the art.

The functionalized isotactic polystyrene of the invention generally has a molecular weight distribution M_{w}/Mₙ of ≦3.1, preferably ≦2.5, particularly preferably ≦2.0, very particularly preferably ≦1.8.

The molecular weight of the functionalized isotactic polystyrenes of the invention (number average molecular weight, Mₙ) is dependent on the desired application and is generally from 2000 to 900 000 g/mol.

M_{w}/Mₙ and Mₙ are determined by means of GPC measurements in chloroform or trichlorobenzene.

The functionalized isotactic polystyrenes of the invention are used to prepare macromonomers, macroinitiators, coupling reagents and, by further reaction of the functionalized isotactic polystyrenes, block and graft copolymers and also inorganic/organic hybrids having stereoregular, narrowly distributed polystyrene segments or can provide a route to these.

The present invention further provides for the use of the functionalized isotactic polystyrene of the invention as macromonomer. Furthermore, further functionalizations, e.g. of at least one double bond of the functionalized isotactic polystyrene of the invention, are possible, so that this can, for example, be used, after polymer-analogous halogenation, as macroinitiator.

Preferred further functionalizations of the functionalized isotactic polystyrene of the invention are mentioned by way of example below. A person skilled in the art will know that the following further functionalizations represent only a selection from among numerous further functionalizations. In principle, the functionalized isotactic polystyrenes of the invention can be functionalized further by means of all methods known to those skilled in the art. The further functionalization makes it possible to obtain novel (co)polymers, in particular block copolymers, which can be used, for example, for producing novel materials.

### a) Polymer-Analogous Halogenation

One possible further functionalization is the polymer-analogous halogenation of the functionalized isotactic polystyrene of the invention. The polystyrene of the invention, which is functionalized at least one chain end by a group IVa or a group IVb, can in principle be functionalized further. Preference is given to carrying out a further functionalization of the polystyrene of the invention having a group IVa at least one chain end. R⁶ in the group IVa is in this case particularly preferably not an OH group.

The present invention therefore further provides a process for preparing a macroinitiator by polymer-analogous halogenation of the functionalized isotactic polystyrene of the invention.

Furthermore, the present invention provides a macroinitiator which can be prepared by the abovementioned halogenation process of the invention and the use of the macroinitiator of the invention as macroinitiator for controlled free-radical polymerization (ATRP).

Polymer-analogous halogenations and suitable reaction conditions and halogenating agents are known to those skilled in the art.

According to the invention, preference is given to carrying out a polymer-analogous bromination. Suitable brominating agents and reaction conditions are known to those skilled in the art. For example, the bromination can be carried out using N-bromo-succinimide as brominating agent in the presence of a free-radical initiator, e.g. AIBN, under reaction conditions known to those skilled in the art. Work-up of the reaction mixture by methods known to those skilled in the art gives a brominated derivative of the polystyrene of the invention which is, for example, suitable as macroinitiator in controlled free-radical polymerization (ATRP). Suitable copolymers for ATRP are, for example, acrylates such as t-butyl acrylate, methacrylates, acrylic acid, methacrylic acid, styrene, acrylonitrile, dienes such as butadiene and other monomers customarily used in free-radical polymerization. The reaction conditions for ATRP are known to those skilled in the art. ATRP using the halogenated derivative of the polystyrene of the invention as macroinitiator makes it possible to obtain, for example, novel stereoregular diblock copolymers, as shown by way of example in scheme 1 below:

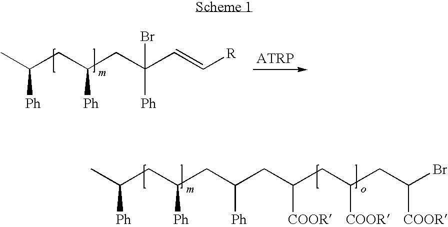

In scheme 1, the indices and radicals have the following meanings:
R is

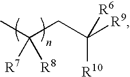

where the radicals and indices R⁶, R⁷, R⁸, R⁹, R¹⁰ and n
have the meanings given for the group IVa;
R′ is t-butyl or H;
m is the number of repeating units based on styrene monomers;
o is the number of repeating units based on t-butyl acrylate or acrylic acid monomers.
   b) Use as Macromonomers—Homopolymerization or Copolymerization with Olefins

In a further embodiment of the present invention, the functionalized isotactic polystyrene of the invention can be used as macromonomer, which likewise makes it possible to obtain novel (co)polymers. Preference is given to using an isotactic polystyrene according to the invention which is functionalized at least one chain end by a group IVb as macromonomer, i.e. the isotactic polystyrene according to the invention which is preferably used as macromonomer is vinyl-terminated.

The present invention therefore further provides for the use of the functionalized isotactic polystyrene of the invention which has a group IVb at least one chain end as vinyl-terminated macromonomer, preferably in copolymerization with olefins.

An example of the use of the vinyl-terminated isotactic polystyrenes of the invention as macromonomers is the homopolymerization of the macromonomers or the copolymerization with olefins to produce novel polyolefins having lateral stereoregular polystyrenes. Suitable olefins are, for example, ethene, propene or further 1-olefins such as 1-hexene or styrene. Suitable reaction conditions and catalysts for the copolymerization are known to those skilled in the art.

### c) Coupling Reactions

The vinyl-terminated isotactic polystyrenes of the invention can also be used in coupling reactions. Suitable coupling reactions are, for example, coupling reactions with SiH groups. The reactants and reaction conditions for such coupling reactions are known to those skilled in the art. Coupling reactions of the macromonomer of the invention (which is used here for effecting coupling) with SiH groups make it possible to obtain, for example, diblock and triblock copolymers having silicone segments when bifunctional silicones are used.

Scheme 2 below shows examples in which the vinyl-terminated polystyrene of the invention is used as macromonomer for copolymerization with olefins or in coupling reactions with silicones:

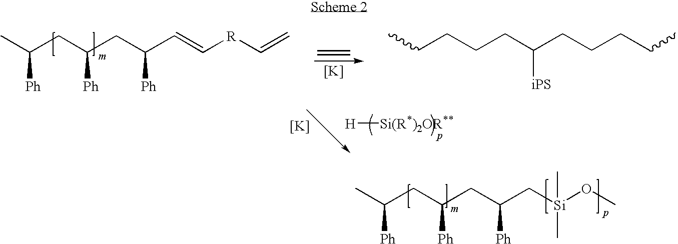

In scheme 2:
[K] is a catalyst, with suitable catalysts being known to those skilled in the art;
m is the number of repeating units based on styrene monomers;
R is

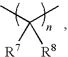

where the radicals and indices R⁷ and R⁸ and n have the meanings given in the case of the group IVb;
R*, R** are each C₁-C₆-alkyl or C₆-C₂₀-aryl;
p is generally from 5 to 400.

### d) Epoxidation

The double bond(s) present in the functionalized isotactic polystyrene of the invention can be epoxidized by methods known to those skilled in the art.

The present invention thus further provides a process for epoxidizing the functionalized isotactic polystyrene of the invention by reaction with an epoxidizing agent, and also an epoxidized isotactic polystyrene which can be prepared by the process of the invention.

Suitable epoxidizing agents are known to those skilled in the art. Examples of suitable epoxidizing agents are H₂O₂, peracids and others.

Epoxidation of the double bond(s) makes this/these available for coupling with nucleophiles such as amines, carboxylates or phenoxides. Numerous novel stereoregular block copolymers can be obtained in this way.

Preference is given to epoxidizing a vinyl-terminated isotactic polystyrene according to the invention, i.e. an isotactic polystyrene according to the invention which has a group IVb at least one chain end.

In scheme 3 below, an epoxidized polystyrene according to the invention and a subsequent coupling reaction with nucleophiles are shown by way of example:

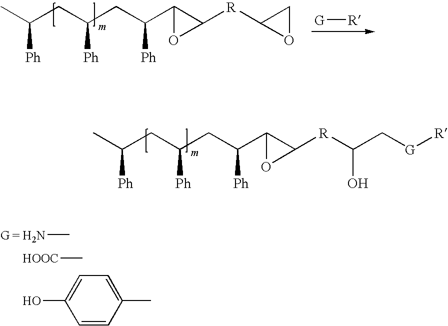

In scheme 3,
m is the number of repeating units based on styrene monomers;
R is

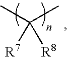

where the radicals and indices R⁷ and R⁸ and n have the meanings given in the case of the group IVb;
R′ is a functional polar unit, e.g. polyamide, PET, PEO, PPO or polyester.

### e) Use in ROMP and in the Preparation of Soft, Thermoplastic Elastomers by ADMET

A further example of the use of the vinyl-terminated isotactic polystyrenes of the invention is their use in the ROMP of cycloolefins. Suitable cycloolefins are, for example, cyclooctadiene, norbornene, dicyclopentadiene and further cycloolefins known to those skilled in the art which can be polymerized by ROMP (further suitable cycloolefins are mentioned below). Suitable reaction conditions and catalysts for ROMP are known to those skilled in the art. This process (ROMP, if appropriate with subsequent hydrogenation by methods known to those skilled in the art) makes it possible to obtain both saturated and unsaturated stereoregular block copolymers.

An example of an ROMP with cycloolefins is shown, in scheme 4 below.

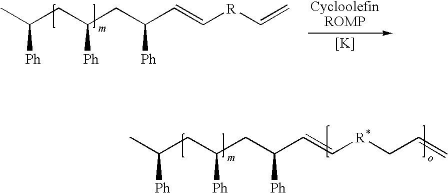

In scheme 4:
m is the number of repeating units based on styrene monomers;
R is

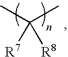

where the radicals and indices R⁷ and R⁸ and n have the meanings given in the case of group IVb;
[K] is a suitable catalyst, with suitable catalysts being known to those skilled in the art (and mentioned below);
o is the number of repeating units based on the cycloolefin used in the ROMP;
   the radicals R* are alkylene groups present in the cycloolefin used in the ROMP.

In a further preferred embodiment, the functionalized isotactic polystyrene of the invention is used in the metathesis polymerization of polymers having terminal double bonds. This makes it possible, for example, to produce novel materials such as soft, thermoplastic elastomers (TPE) which have a high heat distortion resistance.

The present invention thus further provides a process for preparing soft, thermoplastic elastomers, which comprises the step:
ii) metathesis polymerization of the functionalized isotactic polystyrene of the invention with compounds of the general formula V:

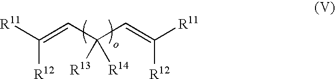

where:
R¹¹, R¹², R¹³, R¹⁴ are each
   H, (C₁-C₆)-alkyl, preferably H, (C₁-C₄)-alkyl, particularly preferably H, methyl, with very particular preference being given to R¹³ and R¹⁴ and at least one of the radicals R¹¹ and R¹² in each case being H and the other radicals R¹¹ or R¹² being H or methyl and especial preference being given to R¹¹, R¹², R¹³, R¹⁴ each being H;
o is from 2 to 10, preferably from 2 to 8, particularly preferably from 4 to 8, very particularly preferably 6;
   in the presence of a metathesis catalyst.

Preference is given to using compounds of the formula V in which:

### R¹², R¹³, R¹⁴

are each hydrogen;
   R¹¹ is H or methyl;
   o is 6,
   in the metathesis process of the invention.

Suitable metathesis catalysts are all metathesis catalysts known to those skilled in the art.

Metathesis catalysts which are preferably used in the metathesis process of the invention are the “Grubbs” catalysts, which are ruthenium-carbene complexes. Such “Grubbs” catalysts are known to those skilled in the art. A “Grubbs” catalyst which is preferably used has, for example, the following formula:

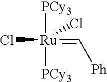

Apart from the abovementioned ruthenium-carbene catalyst, further ruthenium-carbene complexes are known as catalysts to those skilled in the art and can likewise be used in the metathesis process of the invention. Apart from ruthenium-carbene complexes which bear phosphane ligands in addition to halide ligands and the carbene, it is also possible to use the second generation “Grubbs” catalysts as are disclosed, for example, in R. H. Grubbs, Handbook of Metathesis, Vol. 1, p. 128, Wiley-VCH, 2003. These second generation “Grubbs” catalysts are catalysts which bear N-heterocyclic carbene ligands in addition to or in place of the phosphane ligands. Examples of suitable second generation “Grubbs” catalysts are shown below:

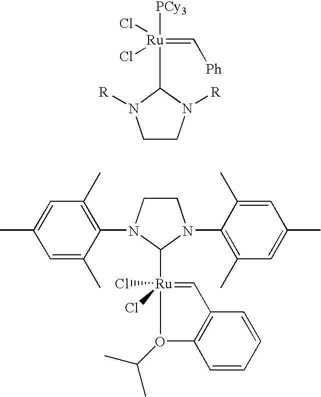

These abovementioned ruthenium-carbene complexes are merely examples of suitable “Grubbs” catalysts. Further “Grubbs” catalysts are known to those skilled in the art.

The compounds of the general formula V can be prepared by processes known to those skilled in the art. A suitable process for preparing the compounds of the general formula V is metathesis polymerization of suitable open-chain or cyclic monomers.

Suitable cyclic monomers can be reacted in a ring opening metathesis polymerization (ROMP) to form the corresponding compounds of the general formula V, giving compounds of the formula V in which R¹¹ is H.

Suitable monomers for ROMP to produce compounds of the formula V have the general formula VI:

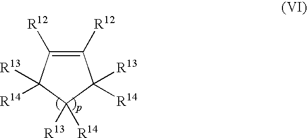

where:
R¹², R¹³, R¹⁴
   have the meanings given above in the case of the formula V;
p is from 0 to 8, preferably from 0 to 6, particularly preferably from 2 to 4, very particularly preferably 4.

Very particular preference is given to using a monomer of the formula VI in which R¹², R¹³ and R¹⁴ are each H or methyl and p is 4 in the ROMP to produce compounds of the general formula V.

Suitable process conditions and catalysts for carrying out ROMP are known to those skilled in the art. Use is usually made of “Grubbs” catalysts, which are Ru-carbene complexes. Catalysts which are preferably used are the catalysts which have been mentioned above in respect of the metathesis polymerization of the functionalized isotactic polystyrene with the compounds of the formula (IV) (step ii)). Suitable process conditions for carrying out ROMP are known to those skilled in the art.

Furthermore, the compounds of the formula V can be obtained by acyclic diene metathesis polymerization (ADMET). In this metathesis polymerization, open-chain dienes having terminal olefinic double bonds are polymerized. Dienes suitable for ADMET have, for example, the general formula VII

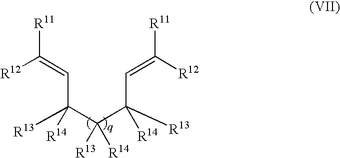

where:
R¹¹, R¹², R¹³, R¹⁴
   have the meanings given in the case of formula IV;
q is from 0 to 8, preferably from 0 to 6, particularly preferably from 2 to 4, very particularly preferably 4.

Suitable reaction conditions and catalysts for carrying out ADMET are known to those skilled in the art. As in ROMP, “Grubbs” catalysts are generally used as catalysts. Catalysts which are preferably used are the catalysts mentioned above in respect of the metathesis polymerization of the functionalized isotactic polystyrene with the compounds of the formula (V) (step ii)).

The preparation of compounds of the formula V which are suitable for the metathesis polymerization according to the invention is illustrated below for the example of a preferred compound of the formula V, without this example constituting a restriction:

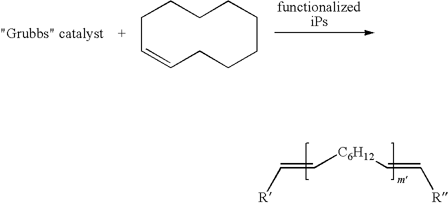

where:
“Grubbs” catalyst is a ruthenium-carbene complex, for example

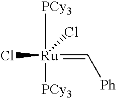

R′, R″ are each H, Me or functionalized iPs, with at least one of the radicals R′ or R″ being iPs;
m′ is from 10 to 100.

The amount of metathesis catalyst is dependent on the desired molar mass. Basically, the higher the amount of catalyst, the lower the molar mass. In general, the metathesis catalyst is used in an amount of from 10 μmol/l to 10 mmol/l in step (ii) of the process.

The molar ratio of functionalized, isotactic polystyrene to the compounds of the formula V is dependent on what products are to be prepared by means of step (ii) of the process. If a triblock copolymer comprising a segment based on compounds of the formula V (B) between two segments of isotactic polystyrene (A) (triblock copolymer ABA) is prepared, the molar ratio of A to B is generally from 1:5 to 1:2000, preferably from 1:10 to 1:1000, particularly preferably from 1:100 to 1:500.

The metathesis polymerization in step (ii) is carried out according to metathesis polymerization processes known to those skilled in the art. The precise procedure is dependent on the desired product. The preparation of a triblock copolymer ABA is preferably carried out under the following reaction conditions:

As solvents, preference is given to using aromatic hydrocarbons such as toluene or halogenated hydrocarbons such as methylene chloride.

The reaction temperature is generally from 20 to 80° C., preferably from 20 to 60° C., particularly preferably from 30 to 50° C.

The reaction time is generally from 0.5 to 100 hours, preferably from 1 hour to 48 hours, particularly preferably from 2 hours to 30 hours. A person skilled in the art will know that reaction times which are shorter or longer than those mentioned above are suitable, although a lower conversion or a greater amount of by-products may be obtained.

The reaction mixture is worked up by processes known to those skilled in the art, in general by deactivation, e.g. by means of ethyl vinyl ether, precipitation and filtration.

The reaction product obtained in the metathesis polymerization (step (ii)) is a block copolymer having segments of stereoregular, narrowly distributed isotactic polystyrene and segments based on the compounds of the general formula V (rubber-like segments). In one embodiment, the metathesis polymerization is followed by a partial hydrogenation of the block copolymer obtained. Suitable reaction conditions are known to those skilled in the art.

It is in principle possible, as mentioned above, to obtain any block copolymers by means of the process of the invention. Preference is given to preparing a triblock copolymer which has a segment based on the compounds of the formula V (B) between two segments of stereoregular, narrowly distributed isotactic polystyrene (A), i.e. a triblock copolymer having the structure ABA. This triblock copolymer is a soft, thermoplastic elastomer having a high heat distortion resistance (TPE). It is a novel material which combines the properties of thermoplastic polymers with those of rubber.

Since the crystallization of isotactic polystyrene is kinetically inhibited, the metathesis polymerization described in step (ii) is generally followed by a crystallization step in which the desired block copolymer is fully crystallized. This crystallization step is generally carried out by addition of a nucleating agent to the reaction mixture obtained in step (ii). Suitable nucleating agents are the nucleating agents customarily used for the crystallization of isotactic polystyrene. Preference is given to using syndiotactic polystyrene (sPS) as nucleating agent, but other nucleating agents described in the literature are also suitable.

In general, the nucleating agent is added to the reaction mixture obtained in step (ii) in an amount of from 0.1 to 10% by weight, preferably from 0.1 to 5% by weight, based on the amount of isotactic polystyrene used.

The present invention further provides a process for preparing soft thermoplastic elastomers (TPE), which comprises the steps:
(i) catalytic polymerization of styrene in the presence of at least one iso-selective metal-organic catalyst and at least one diene having terminal, nonconjugated double bonds of the general formula IIIb

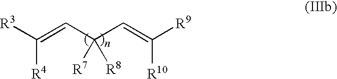

to give functionalized isotactic polystyrene which has an olefinic double bond at at least one chain end;
(ii) metathesis polymerization of the functionalized isotactic polystyrene obtained in step (i) with compounds of the general formula V

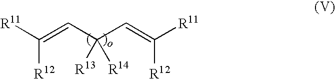

where:
R¹¹, R¹², R¹³, R¹⁴ are each
H, (C₁-C₆)-alkyl, preferably H, (C₁-C₄)-alkyl, particularly preferably H, methyl, with very particular preference being given to R¹², R¹³ and R¹⁴ each being H and R¹¹ being H or methyl;
   o is from 2 to 10, preferably from 2 to 8, particularly preferably from 4 to 8;
   in the presence of a metathesis catalyst;
(iii) crystallization of the reaction product obtained in step (ii) by addition of a nucleating agent, preferably by addition of syndiotactic polystyrene (sPS).

The process of the invention makes it possible to obtain novel materials which combine the properties of thermoplastic polymers with those of rubber.

The present invention therefore further provides thermoplastic elastomers which can be prepared by the process of the invention comprising the steps (i), (ii) and (iii).

The individual process conditions and preferred reactants in steps (i), (ii) and (iii) have been mentioned above.

The following examples illustrate the invention.

### EXAMPLES

### Preparation of 1,9-decadienyl-Terminated Isotactic Polystyrene

60 ml of toluene and 23 ml of 1,9-decadiene were placed in a 250 ml Schlenk flask. MAO (10% by weight in toluene) was subsequently added (Al:Ti=1500) and the mixture was stirred at RT for 5 minutes. 23 ml of styrene were then added and the reaction mixture was heated to 40° C. 4.02 mg of the catalyst of the formula Ia (62.5 μmol/l) were subsequently dissolved in 8 ml of toluene and the polymerization was started by addition of the catalyst solution. Polymerization was carried out at 40° C. for 1 hour. The reaction was stopped by precipitation in MeOH/HCl. The polymer was filtered off, washed a number of times with methanol and dried overnight at 60° C. in a high vacuum. This gave 10.3 g of 1,9-decadienyl-terminated isotactic polystyrene. Mₙ=1900 g/mol, M_{w}/Mₙ=1.3

### Catalyst:

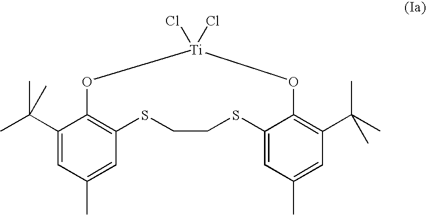

¹H NMR Spectrum of 1,9-decadienyl-Terminated Isotactic Polystyrene:

¹H NMR (300 MHz, CDCl₃, 300 K): δ=7.25-6.50 (m, br, H ar.), 5.80 (m, —CH═CH₂), 5.12 (m, —CH═CH—), 4.97 (dd, —CH═CH₂), 2.48-1.95 (m, br, CH backbone), 1.95-0.65 (m, br, CH₂ backbone, alkyl).

¹³C NMR Spectrum of 1,9-decadienyl-Terminated Isotactic Polystyrene:

¹³C NMR (75 MHz, CDCl₃, 300 K): δ=146.3 (ipso-C), 139.2 (—CH═CH₂), 131.9 (—CH═CH—), 128.2, 127.4, 125.8, 114.1 (—CH═CH₂), 42.9 (CH₂ backbone), 40.5 (CH backbone), 39.0, 36.6 (CH₃—CHPh-), 33.8, 32.3, 29.1, 20.8 (CH₃—CHPh-).

Ring-Opening Metathesis Polymerization of Cyclooctene Using 1,9-decadienyl-Terminated iPs as Regulator

### General Method:

1,9-Decadienyl-terminated iPS (Mₙ=2000 g/mol) is placed in a Schlenk flask and dissolved in toluene. Cyclooctene (COE) (c=0.2 mol/l) is added to the solution. The catalyst of the formula VIII is dissolved in toluene and transferred into the reaction flask. The reaction mixture is then heated to 55° C. and stirred under argon for 24 hours. The reaction is stopped by addition of ethyl vinyl ether. After addition of BHT, the polymer is obtained by precipitation in methanol. The polymer is filtered off, washed a number of times with methanol and dried overnight at 60° C. in a high vacuum.

### Catalyst:

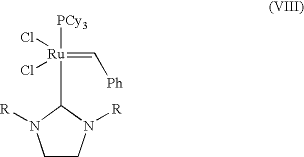

R is in each case mesityl.

TABLE 1
Reaction parameters for the ring-opening metathesis polymerization
of cyclooctene using 1,9-decadienyl-terminated iPS as regulator

| | | | | | Weight | | |
|---|---|---|---|---|---|---|---|
| | [COE]/ | [COE]/ | | V_{(COE)} | used | Yield | Styrene/COE |
| No. | [iPS] | [cat] | [g] | [ml] | [g] | [%] | (from NMR) |
| 1 | 20 | 4000 | 0.20 | 0.26 | 0.14 | 33 | 1:1.9 |
| 2 | 50 | 4000 | 0.15 | 0.50 | 0.38 | 25 | 1:2.6 |
| 3 | 100 | 4000 | 0.073 | 0.5 | 0.25 | 51 | 1:4.3 |
| 4 | 500 | 4000 | 0.08 | 2.6 | 1.68 | 56 | 1:9 |
| 5 | 1000 | 4000 | 0.07 | 4.6 | 2.11 | 54 | 1:31 |
| 6 | 100 | 500 | 0.10 | 0.65 | | | |
| 7 | 100 | 2000 | 0.10 | 0.65 | 0.53 | 82 | 1:9 |
| 8 | 100 | 8000 | 0.10 | 0.65 | 0.22 | 34 | 1:5.4 |

¹H NMR Spectrum of PCOE/1,9-decadienyl-Terminated iPS.

¹H NMR (300 MHz, CDCl₃, 300 K): δ=7.25-6.50 (m, br, H arom.), 5.80 (m, —CH═CH₂), 5.41 (m, br, —CH═CH—PCOE), 5.03 (m, —CH═CH—, —CH═CH₂ iPS), 2.02 (m, br, ═CH—CH₂—), 1.41 (m, br, ═CH—CH₂—CH₂—CH₂—), 2.5-0.75 (m, br, backbone iPS).

13C NMR Spectrum of PCOE/1,9-decadienyl-Terminated iPS

¹³C NMR (75 MHz, CDCl₃, 300 K): δ=146.3 (ipso-C), 139.2 (—CH═CH₂ iPS), 130.4 (trans-CH═CH—PCOE), 129.9 (cis-CH═CH—PCOE), 128.2, 127.4, 125.8, 114.1 (—CH═CH₂ iPS), 42.9 (CH₂ backbone iPS), 40.5 (CH backbone iPS), 35.6, 32.6 (trans-CH₂—CH═PCOE), 29.7 (CH₂ PCOE), 29.1 (CH₂ PCOE), 27.2 (cis-CH₂—CH═PCOE).

Epoxidation of 1,9-decadienyl-Terminated iPS

3.0 g of 1,9-decadienyl-terminated iPS (Mₙ=2000 g/mol, 1.5 mmol) were placed in a 250 ml round-bottom flask and dissolved in 100 ml of chloroform. 0.925 g of MCPBA (technical grade 70%, 3.75 mmol) was dissolved in 20 ml of chloroform and slowly added dropwise to the polymer solution. The reaction mixture was stirred overnight under argon at room temperature. 50 ml of saturated Na₂CO₃ solution were added and the phases were separated. The organic phase was washed with distilled water (2×50 ml) and saturated NaCl solution (50 ml) and the solvent was removed under reduced pressure. The residue was taken up in 20 ml of toluene and precipitated in methanol. The polymer was filtered off, washed a number of times with methanol and dried overnight at 60° C. in a high vacuum. This gave 2.65 g of polymer.

¹H NMR Spectrum of Epoxidized iPS-decadienyl

¹H NMR (300 MHz, CDCl₃, 300 K): δ=7.25-6.50 (m, br, H ar.), 5.80 (m, —CH═CH₂), 4.97 (dd, —CH═CH₂), 3.90-3.38 (m, dial-CH), 2.79 (m, CH), 2.65 (m, CH), 2.36 (m, CH), 2.48-1.95 (m, br, CH backbone), 1.95-0.65 (m, br, CH₂ backbone, alkyl).

A comparison of samples which were reacted with various numbers of equivalents of MCPBA shows that the internal double bond is epoxidized first. Complete epoxidation of the iPS samples is possible, with some opening to form the dial already occurring at 5 eq of MCPBA.

¹³C NMR Spectrum of Epoxidized iPS-decadienyl

¹³C NMR (75 MHz, CDCl₃, 300 K): δ=146.3 (ipso-C), 139.2 (—CH═CH₂), 131.9 (—CH═CH—), 128.2, 127.4, 125.8, 114.1 (—CH═CH₂), 71.4 (diol-CH), 67.0 (diol-CH), 59.6, 58.7, 57.4, 57.0 (CH internal epoxide), 52.3 (CH, terminal epoxide), 47.0 (CH₂, terminal epoxide), 42.9 (CH₂ backbone), 40.5 (CH backbone), 39.0, 36.6 (CH₃—CHPh-), 32.3, 31.7, 29.1, 25.8, 20.8 (CH₃—CHPh-).

### Epoxide Opening by Means of N-Octylamine

0.15 g of 1,9-decadienyl-terminated iPS (Mn=2000 g/mol, 0.075 mmol) was placed in a Schlenk tube and dissolved in 1 ml of chloroform. 1.23 ml of n-octylamine (7.5 mmol, 0.97 g) were then added and the reaction mixture was stirred under argon at 45° C. for 7 days. The reaction was stopped by precipitation in methanol. The polymer was filtered off, washed a number of times with methanol and dried overnight at 60° C. in a high vacuum. This gave 0.13 g of polymer.

¹H NMR Spectrum after Epoxide Opening by Means of Octylamine

¹H NMR (300 MHz, CDCl₃, 300 K): δ=7.25-6.50 (m, br, H ar.), 5.80 (m, —CH═CH₂), 4.97 (dd, —CH═CH₂), 3.60 (m, diol), 2.65 (m, NH—CH₂), 2.48-1.95 (m, br, CH backbone), 1.95-0.65 (m, br, CH₂ backbone, alkyl), 1.28 (m, octyl-CH₂), 0.88 (t, —CH₂CH₃).

Complete reaction of all terminal epoxide groups is achieved, as can be seen from the characteristic signals of octylamine (1.28 and 0.88 ppm).

¹³C NMR Spectrum of iPS after Epoxide Opening by Means of Octylamine

¹³C NMR (75 MHz, CDCl₃, 300 K): δ=146.3 (ipso-C), 139.2 (—CH═CH₂), 131.9 (—CH═CH—), 128.2, 127.4, 125.8, 114.1 (—CH═CH₂), 71.4 (diol-CH), 67.0 (diol-CH), 59.6, 58.7, 57.4, 57.0 (CH internal epoxide), 52.3 (CH, terminal epoxide), 40.5 (CH backbone), 39.0, 36.6 (CH₃—CHPh-), 32.3, 31.7, 29.1, 27.2, 26.4, 23.4, 22.6 (octyl-CH₂), 20.8 (CH₃—CHPh-), 14.1 (octyl-CH₃).

Hydrosilylation of 1,9-decadienyl-Terminated iPS by Means of Pentamethyldisiloxane

0.25 g of 1,9-decadienyl-terminated iPS (Mₙ˜2000 g/mol, n=0.125 mmol) was placed in a Schlenk tube and dissolved in 15 ml of toluene. 0.25 ml of pentamethyldisiloxane (0.125 mmol, 0.0185 g) was added and the reaction mixture was heated to 40° C. 0.28 μl of Karstedt catalyst (Pt(0)-1,3-divinyl-1,1,3,3 tetramethyldisiloxane) (3% strength by weight in xylene, 2.5×10⁻⁸ mol, 1.9×−10⁻⁶ mol/l) was then added and the mixture was stirred at 40° C. for 1 hour. The reaction was stopped by precipitation in methanol. The polymer was separated off from the methanol and taken up in dichloromethane. Removal of the solvent gave 0.16 g of iPS-PMDS.

¹H NMR Spectrum of iPS-PMDS

¹H NMR (300 MHz, CDCl₃, 300 K): δ=7.25-6.50 (m, br, H ar.), 5.80 (m, —CH═CH₂), 5.12 (m, —CH═CH—), 4.97, (dd, —CH═CH₂), 2.48-1.95 (m, br, CH backbone), 1.95-0.65 (m, br, CH₂ backbone, alkyl), 0.58 (m, —CH₂—Si(CH₃)₂—), 0.13 (m, Si(CH₃)₂, Si(CH₃)₃).

The NMR spectra indicate a reaction of about 0.8 terminal double bonds of the iPS with PMDS. Another characteristic is the new peak at 0.58 ppm, which is the methylene group next to the disiloxane.

¹³C NMR Spectrum of iPS-PMDS

¹³C (75 MHz, CDCl₃, 300 K): b=146.3 (ipso-C), 139.2 (—CH═CH₂), 131.9 (—CH═CH—), 128.2, 127.4, 125.8, 114.1 (—CH═CH₂), 42.9 (CH₂ backbone), 40.5 (CH backbone), 39.0, 36.6 (CH₃—CHPh-), 33.8, 32.3, 29.1, 23.3 (—CH₂—CH₂—Si(CH₃)₂—), 20.8 (CH₃—CHPh-), 18.4 (CH₂—CH₂—Si(CH₃)₂—), 2.0 (CH₃—Si), 0.4 (CH₃—Si).

Hydrosilylation of 1,9-decadienyl-Terminated iPS by Means of di-H-Terminated poly(dimethylsiloxane)

0.50 g of decadienyl-terminated iPS (Mₙ˜2000 g/mol, 0.25 mmol) was placed in a Schlenk tube and dissolved in 10 ml of toluene. 0.06 ml of di-H-PDMS (M=400-500 g/mol, 0.125 mmol, 0.056 g) was added and the reaction mixture was heated to 40° C. 0.55 μl of Karstedt catalyst (3% strength by weight in xylene, 4.9×−10⁻⁹ mol, 4.9×−10⁻⁶ mol/l) was then added and the mixture was stirred at 40° C. for 2 hours. The reaction was stopped by precipitation in methanol. The polymer was filtered off, washed a number of times with methanol and dried overnight at 60° C. in a high vacuum. This gave 0.45 g of polymer.

¹H NMR Spectrum of iPS-PDMS-iPS

¹H NMR (300 MHz, CDCl₃, 300 K): b=7.25-6.50 (m, br, H ar.), 5.80 (m, —CH═CH₂), 5.12 (m, —CH═CH—), 4.97 (dd, —CH═CH₂), 2.48-1.95 (m, br, CH backbone), 1.95-0.65 (m, br, CH₂ backbone, alkyl), 0.60 (m, —CH₂—Si(CH₃)₂—)_{,} 0.13 (m, Si(CH₃)₂).

A comparison of the spectra of the starting material and product indicates reaction of one terminal double bond per iPS chain. In addition, a new signal having an integral of 2H appears at 0.60 ppm, which can be assigned to the methylene group next to the PDMS block. Since iPS and PDMS were used in a ratio of 2:1 and there are no longer any terminal H atoms of the PDMS block present, it can be assumed that an iPS-PDMS-iPS triblock copolymer has been formed.

¹³C NMR Spectrum of iPS-PDMS-iPS

¹³C (75 MHz, CDCl₃, 300 K): b=146.3 (ipso-C), 139.2 (—CH═CH₂), 131.9 (—CH═CH—), 128.2, 127.4, 125.8, 114.1 (—CH═CH₂), 42.9 (CH₂ backbone), 40.5 (CH backbone), 39.0, 36.6 (CH₃—CHPh-), 33.8, 32.3, 29.1, 23.2 (—CH₂—CH₂—Si(CH₃)₂—), 20.8 (CH₃—CHPh-), 18.3 (CH₂—CH₂—Si(CH₃)₂—), 1.1 (CH₃—Si), 0.2 (CH₃—Si).

1-21. (canceled)

22. A process for preparing functionalized isotactic polystyrene, which comprises the step:
(i) catalytic polymerization of styrene in the presence of at least one iso-selective metal-organic catalyst and at least one C₅-C₃₀-olefin which has a further function in addition to the double bond.

23. The process according to claim 22, wherein the further function is a further double bond which is not conjugated with the double bond present in the C₅-C₃₀-olefin or a group selected from among OH, amino, halogen and alkylsilyl groups.

24. The process according to claim 22, wherein a catalyst of the general formula I: 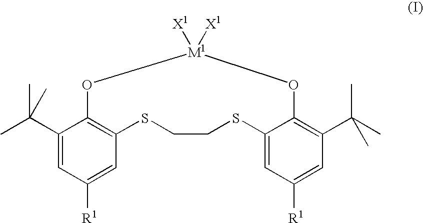
where M¹, R¹, X¹ in the formula I have, independently of one another, the following meanings:
M¹ is Ti, Zr, Hf;
R¹ is (C₁-C₆)-alkyl, O—(C₁-C₆)-alkyl;
X¹ is halogen, O—(C₁-C₄)-alkyl, aralkyl,
is used as catalyst.

25. The process according to claim 22, wherein the C₅-C₃₀-olefin has the general formula IIIa or IIIb 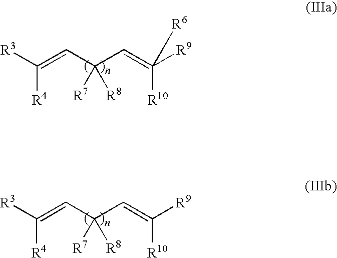
where:
R³, R⁴, R¹⁰, R⁷, R⁸, R⁹ are each H, (C₁-C₆)-alkyl;
R⁶ is OH, amino, halogen or alkylsilyl;
n is from 2 to 10.

26. A functionalized isotactic polystyrene which is functionalized at least one chain end by a group selected from among the groups IVa and IVb 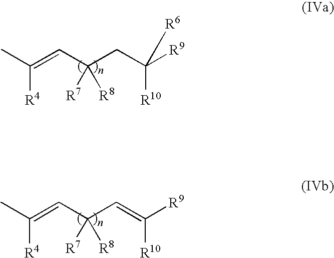
where:
R⁴, R¹⁰, R⁷, R⁸, R⁹ are each H, (C₁-C₆)-alkyl;
R⁶ is OH, amino, halogen or alkylsilyl;
n is from 2 to 10;
and can be prepared according to claim 25.

27. The functionalized isotactic polystyrene according to claim 26, which has an iso-specificity of ≧94%.

28. The functionalized isotactic polystyrene according to claim 26, which has a molecular weight distribution M_{w}/Mₙ of ≦3.1.

29. The functionalized isotactic polystyrene according to claim 26, which has a number average molecular weight Mₙ of from 2000 to 900 000 g/mol.

30. A process for preparing a macroinitiator by polymer-analogous halogenation of the functionalized isotactic polystyrene according to claim 26.

31. A macroinitiator which can be prepared by a process according to claim 30.

32. A process for epoxidizing the functionalized isotactic polystyrene according to claim 26 by reaction with an epoxidizing agent.

33. An epoxidized isotactic polystyrene which can be prepared by a process according to claim 32.

34. A process for preparing soft thermoplastic elastomers, which comprises the step:
(ii) metathesis polymerization of functionalized isotactic polystyrene according to claim 26 in which at least one chain end is substituted by a group IVb with compounds of the general formula V 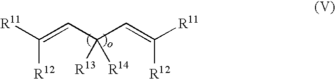
where:
R¹¹, R¹², R¹³, R¹⁴ are each H, (C₁-C₆)-alkyl;
o is from 2 to 10;
in the presence of a metathesis catalyst.

35. The process according to claim 34, wherein the radicals and groups in the compound of the formula V have the following meanings:
R¹², R¹³, R¹⁴ are each H;
the radicals R¹¹ are each, independently of one another, H, methyl;
o is 6.

36. The process according to claim 34, wherein the metathesis catalyst is a ruthenium-carbene complex.

37. The process according to claim 34, wherein a nucleating agent is added (step (iii)) after step (ii).

38. A process according to claim 34 wherein before step (ii) the following step (i) is performed.
(i) catalytic polymerization of styrene in the presence of at least one iso-selective metal-organic catalyst and at least one diene having terminal, nonconjugated double bonds to give functionalized isotactic polystyrene which has a group of the formula IVb at at least one chain end; 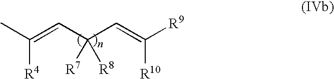
where
R⁴, R¹⁰, R⁷, R⁸, R⁹ are each H, (C₁-C₆)-alkyl;
n is from 2 to 10.

39. A soft thermoplastic elastomer, which can be prepared by a process according to claim 34.

40. The process according to claim 23, wherein a catalyst of the general formula I: 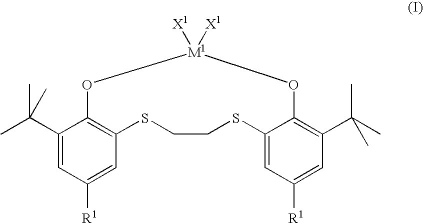
where M¹, R¹, X¹ in the formula I have, independently of one another, the following meanings:
M¹ is Ti, Zr, Hf;
R¹ is (C₁-C₆)-alkyl, O—(C₁-C₆)-alkyl;
X¹ is halogen, O—(C₁-C₄)-alkyl, aralkyl,
is used as catalyst.

41. The process according to claim 23, wherein the C₅-C₃₀-olefin has the general formula IIIa or IIIb 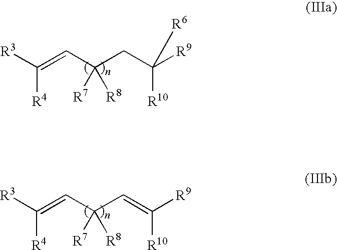
where:
R³, R⁴, R¹⁰, R⁷, R⁸, R⁹ are each H, (C₁-C₆)-alkyl;
R⁶ is OH, amino, halogen or alkylsilyl;
n is from 2 to 10.
